(19) United States
(12) Patent Application Publication
(10) Pub. No.: US 2020/0163160 A1
(43) Pub. Date: May 21, 2020

(54) PASSIVE ANTI-ICING AND/OR DEICING SYSTEMS

(71) Applicant: Goodrich Corporation, Charlotte, NC (US)

(72) Inventors: John J. Gangloff, JR., East Hartford, CT (US); Andrew Taylor, Hudson Village, OH (US); James A, Mullen, Wadsworth, OH (US); Danielle L. Grolman, East Hartford, CT (US); Peter J. Walsh, Wethersfield, CT (US)

(21) Appl. No.: 16/198,179

(22) Filed: Nov. 21, 2018

(51) Int. Cl. H05B 1/02; B32B 7/12; B32B 25/08; B32B 25/20

(52) U.S. Cl. CPC H05B 1/0236; B32B 7/12; B64D 15/00; B32B 25/20; B32B 25/08

(57) ABSTRACT

A passive anti-icing and/or deicing device can include an icephobic outer layer configured to prevent ice from forming and/or building up on the outer layer by preventing ice from adhering to the outer layer. The device can include a backer film attached to an underside of the icephobic outer layer, and an adhesive attached to the backer film on an opposite side of the backer film relative to the icephobic outer layer.

### BACKGROUND

### 1. Field

The present disclosure relates to deicing and/or anti-icing systems, e.g., for aircraft.

### 2. Description of Related Art

Ice on external aircraft surfaces can lead to dangerous flight conditions, including unsafe aerodynamic control surfaces. Aerospace deicing needs are currently addressed by external bladders or heating. It is desirable to improve the performance of current deicing technologies to reduce their overall aircraft power and weight performance penalties. There are also technical needs for deicing in aircraft locations not easily accessible by current deicing technologies, for example.

Conventional methods and systems have generally been considered satisfactory for their intended purpose. However, there is still a need in the art for improved anti-icing and deicing systems. The present disclosure provides a solution for this need.

### SUMMARY

In accordance with at least one aspect of this disclosure, a passive anti-icing and/or deicing device can include an icephobic outer layer configured to prevent ice from forming and/or building up on the outer layer by preventing ice from adhering to the outer layer. The device can include a backer film attached to an underside of the icephobic outer layer, and an adhesive attached to the backer film on an opposite side of the backer film relative to the icephobic outer layer.

The icephobic outer layer can be or include an elastomeric reservoir at least partially saturated with an icephobic and/or hydrophobic lubricant. In certain embodiments, the backer film can be chemically bonded to the elastomeric reservoir. For example, the backer film and the icephobic outer layer are covalently bonded together. Any other suitable bonding and/or attachment is contemplated herein.

The backer film can be made of polyethylene terephthalate (PET), polyamide (PA) or urethane, for example. The backer film can be functionalized with silanes or other low molecular weight molecules having reactive end groups to create covalent bonding and enhanced adhesion to the elastomeric reservoir. The reactive end groups could include vinyl, hydride, silanol, amine, epoxide, carbinol, methacryalate and acrylate moieties. The elastomeric reservoir can be made of silicone. Any other suitable material(s), e.g., configured to allow chemical bonding with both the elastomeric reservoir and the adhesive, is contemplated herein.

The adhesive can be made of a material that chemically bonds with the backer film. In certain embodiments, the adhesive can be a pressure sensitive adhesive (PSA). Any other suitable adhesive and/or type of bonding or attachment is contemplated herein.

The adhesive can be configured to bond to at least one of aluminum, fiberglass, or composite material (e.g., an aircraft structure). Any other suitable material for the adhesive to be used to bond to is contemplated herein.

In accordance with at least one aspect of this disclosure, an aircraft anti-icing and/or deicing system can include an aircraft structure having a surface and an icephobic outer layer bonded to the surface of the aircraft structure and configured to prevent ice from forming and/or building up on the outer layer by preventing ice from adhering to the outer layer. The icephobic outer layer can include an elastomeric reservoir at least partially saturated with an icephobic and/or hydrophobic lubricant.

The structure can include an aircraft wing. The icephobic outer layer can be disposed on a majority of an upper surface of the wing. In certain embodiments, the icephobic outer layer can be disposed downstream of a pneumatic or electrically heated deicer.

In certain embodiments, the structure can include a pneumatic deicing bladder and/or an electrically heated deicer. In such embodiments, for example, the elastomeric reservoir can be chemically bonded directly to the surface of the structure. The surface of the structure can be silanized to bond to the elastomeric reservoir.

In accordance with at least one aspect of this disclosure, a method can include chemically bonding a backer film to an elastomeric reservoir that is saturated with an icephobic and/or hydrophobic lubricant. The method can also include chemically bonding an adhesive to an opposite side of the backer film.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a cross-sectional elevation view of an embodiment of a device in accordance with this disclosure, shown attached to a structure;

FIG. 2 is a perspective view of an embodiment of a system in accordance with this disclosure;

FIG. 3 is a perspective view of an embodiment of a system in accordance with this disclosure;

FIG. 4 is a perspective view of an embodiment of a system in accordance with this disclosure.

FIG. 5 is a cross-sectional elevation view of an embodiment of a system in accordance with this disclosure; and

FIG. 6 is a cross-sectional elevation view of an embodiment of a system in accordance with this disclosure.

### DETAILED DESCRIPTION

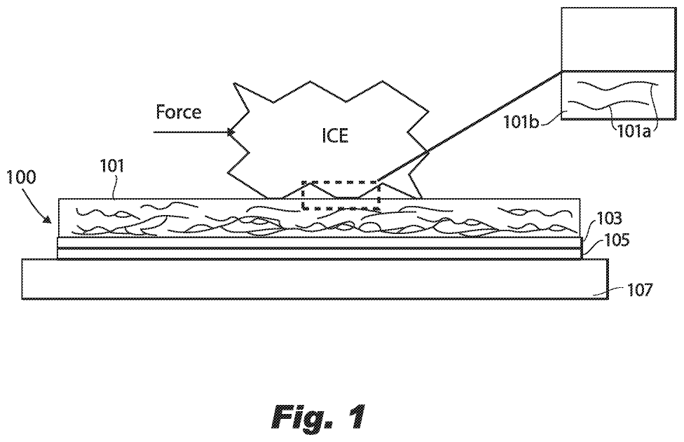

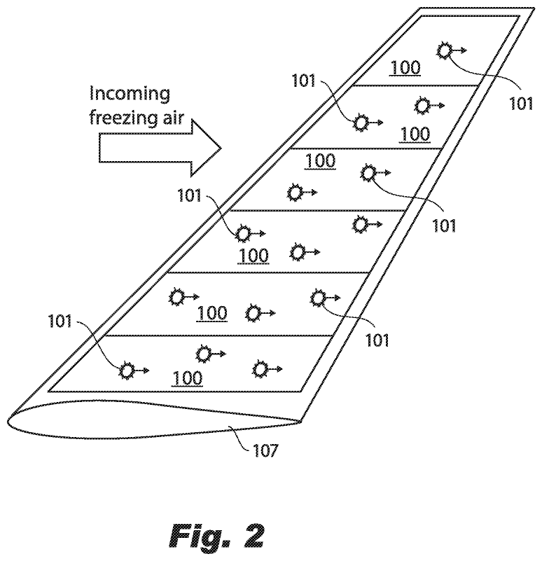

Reference will now be made to the drawings wherein like reference numerals identify similar structural features or aspects of the subject disclosure. For purposes of explanation and illustration, and not limitation, an illustrative view of an embodiment of a device in accordance with the disclosure is shown in FIG. 1 and is designated generally by reference character 100. Other embodiments and/or aspects of this disclosure are shown in FIGS. 2-6. The systems and methods described herein can be used to prevent icing or aid in deicing.

Referring to FIG. 1, a passive anti-icing and/or deicing device 100 can include an icephobic outer layer 101 configured to prevent ice from forming and/or building up on the outer layer 101 by preventing ice from adhering to the outer layer 101. The device 100 can include a backer film 103 attached to an underside of the icephobic outer layer 101, and an adhesive 105 attached to the backer film 103 on an opposite side of the backer film 103 relative to the icephobic outer layer 101.

The icephobic outer layer 101 can be or include an elastomeric reservoir 101a (e.g., made of polydimethylsiloxane or any other suitable material, e.g., polymethylphenylsiloxane, polystyrene, polyisobutylene, fluorinated polyurethanes and polyurethanes). The reservoir can be at least partially saturated with an icephobic and/or hydrophobic lubricant 101b (e.g., an oligomeric or low molecular weight polymeric fluorocarbon, such as a perfluoropolyether or any other suitable material). In certain embodiments, the backer film 103 can be chemically bonded to the elastomeric reservoir 101. For example, the backer film 103 and the icephobic outer layer 101 are covalently bonded together. Any other suitable bonding and/or attachment is contemplated herein.

In certain embodiments, the backer film 103 can be made of polyethylene terephthalate (PET), polyamide (PA) or urethane, for example. The backer film 103 can be functionalized with silanes or other low molecular weight molecules having reactive end groups to create covalent bonding and enhanced adhesion to the elastomeric reservoir 101a to bond to the elastomeric reservoir 101a. The reactive end groups can include one or more of vinyl, hydride, silanol, amine, epoxide, carbinol, methacryalate, or acrylate moieties, for example. The elastomeric reservoir 101a can be made of silicone, for example. Any other suitable material(s), e.g., configured to allow chemical bonding with both the elastomeric reservoir 101a and the adhesive 105, is contemplated herein.

The adhesive 105 can be made of a material that chemically bonds with the backer film 103. In certain embodiments, the adhesive 105 can be a pressure sensitive adhesive (PSA). Any other suitable adhesive and/or type of bonding or attachment is contemplated herein.

The adhesive 105 can be configured to bond to at least one of aluminum, fiberglass, or composite material (e.g., an aircraft structure). Any other suitable material for the adhesive 105 to be used to bond to is contemplated herein.

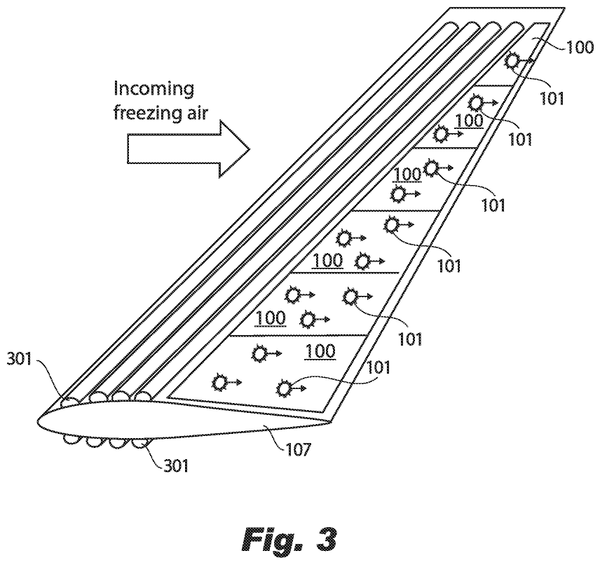

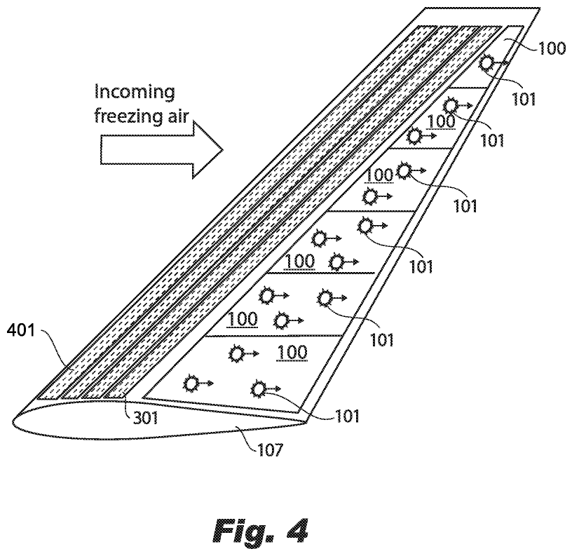

As shown in FIG. 1, the device 100 can be attached to a structure 107 by sticking the adhesive on the surface 107, e.g., and pressing down. For example, the structure 107 can be an aircraft skin or any other suitable structure where ice can form. For example, as shown in FIGS. 2-4, the structure 107 can include an aircraft wing. The device 100 having the icephobic outer layer 101 can be disposed on a majority of an upper surface of the wing, e.g., as shown in FIG. 2. As shown in FIGS. 3 and 4, in certain embodiments, the device 100 having the icephobic outer layer 101 can be disposed downstream of a pneumatic deicer 301 or electrically heated deicer 401. Any suitable size device 100 or coverage area on a structure 107 is contemplated herein (e.g., one or more panels as shown configured to conform to a wing taper).

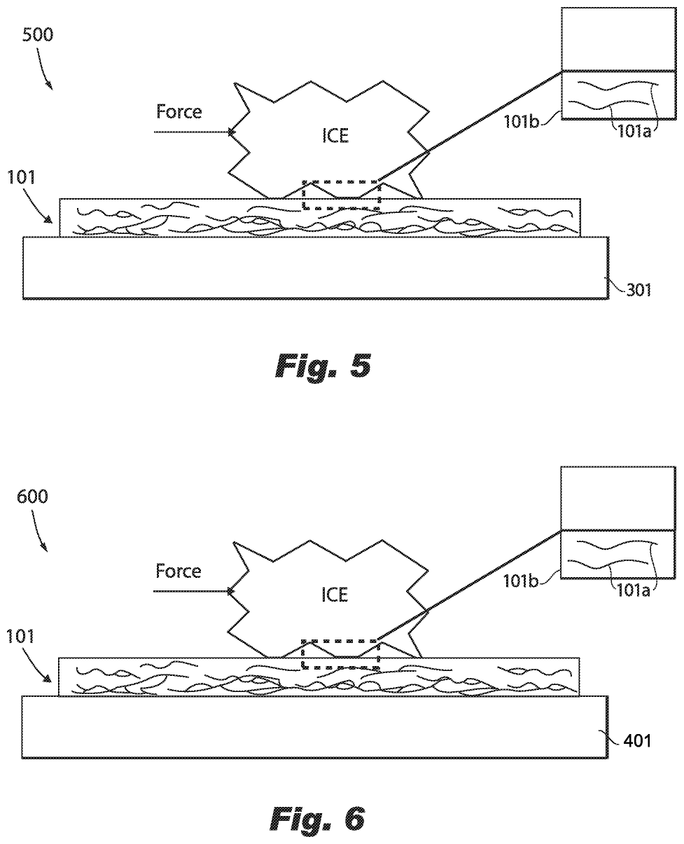

Referring to FIGS. 5 and 6, in accordance with at least one aspect of this disclosure, an aircraft anti-icing and/or deicing system (e.g., system 500, 600) can include an aircraft structure (e.g., pneumatic deicer 301, electrically heated deicer 401) having a surface (e.g., 301a, 401a). The icephobic outer layer 101 can be bonded to the surface of the aircraft structure 301, 401 and can be configured to prevent ice from forming and/or building up on the outer layer 101 by preventing ice from adhering to the outer layer 101. The icephobic outer layer 101 can include any suitable icephobic outer layer 101, e.g., as described above.

In certain embodiments, as shown in FIG. 5, the structure can include a pneumatic deicing bladder 301 (e.g., made of a polymeric material). In certain embodiment, the structure can include an electrically heated deicer 301 (e.g., having an outer surface of a bondable material, e.g., chloroprene or epoxy, or a fiberglass or metal surface). In such embodiments, for example, the elastomeric reservoir 101a can be chemically bonded directly to the surface of the structure. The surface of the structure can be functionalized with silanes having reactive end groups to bond to the elastomeric reservoir 101a, for example. Any other suitable structure and/or bonding chemistry/technique is contemplated herein to bond the outer layer 101 directly to a desired structure. In certain embodiments, the deicers 301, 401 can be fabricated to have an icephobic outer layer 101.

In accordance with at least one aspect of this disclosure, a method can include chemically bonding a backer film to an elastomeric reservoir that is saturated with an icephobic and/or hydrophobic lubricant. The method can also include chemically bonding an adhesive to an opposite side of the backer film.

As disclosed above, certain embodiments include hydroxyl groups (or any other suitable functional group, e.g., formed with energy/heat) on backer film. Silane can then be applied to the hydroxyl groups or other suitable functional group. The silanes can be compatible or covalently boned to the elastomeric reservoir 101a (e.g., made of silicone). The elastomeric reservoir 101a can function like a soaked up sponge to hold the lubricant 101b. The backer film 103 can be a cross-link polymer that is has similar solubility to the lubricant 101b. A PSA can stick to other side of the backer film 103, and also stick to the desired application. Such devices can allow the icephobic surface to be attached to any suitable structure like a sticker. Certain embodiments allow for the icephobic structure to be bonded directly to a desired structure (e.g., where at least the outer layer of the structure material is capable of being bonded).

In accordance with certain embodiments, an elastomeric polymer, e.g., polydimethylsiloxane, is formed into a film and swollen with a lubricant (e.g., an oligomeric or low molecular weight polymeric fluorocarbon, such as a perfluoropolyether). The liquid fluorocarbon can provide a smooth, mobile, icephobic free surface that inhibits the formation of ice and prevent sticking of ice that does form. Embodiments also provides a way to increase the time of icing. The swollen base polymer can be joined to a backer film and a pressure sensitive adhesive which can provides a method for the system to adhere strongly to a structural application substrate. The substrate can consist of a metallic or composite aerospace structure, or surfaces of conventional pneumatic deicing bladders or electrically heated deicers, or any other suitable substrate.

Embodiments provide ice-phobic surfaces that can passively slow ice formation and/or shed ice crystals on aerospace external surfaces. Passive coating-based deicing systems and devices reduce external power and weight penalties compared to current deicing technologies. Embodiments can be applied to exposed portions of nacelle structures, lifting surfaces, engine components, and/or any other suitable aircraft or non-aircraft structure. Embodiments are easily repairable via removal, surface treatment, and re-application of a fresh coating system.

Those having ordinary skill in the art understand that any numerical values disclosed herein can be exact values or can be values within a range. Further, any terms of approximation (e.g., “about”, “approximately”, “around”) used in this disclosure can mean the stated value within a range. For example, in certain embodiments, the range can be within (plus or minus) 20%, or within 10%, or within 5%, or within 2%, or within any other suitable percentage or number as appreciated by those having ordinary skill in the art (e.g., for known tolerance limits or error ranges).

Any suitable combination(s) of any disclosed embodiments and/or any suitable portion(s) thereof are contemplated herein as appreciated by those having ordinary skill in the art.

The embodiments of the present disclosure, as described above and shown in the drawings, provide for improvement in the art to which they pertain. While the subject disclosure includes reference to certain embodiments, those skilled in the art will readily appreciate that changes and/or modifications may be made thereto without departing from the spirit and scope of the subject disclosure.

What is claimed is:

1. A passive anti-icing and/or deicing device, comprising:
an icephobic outer layer configured to prevent ice from forming and/or building up on the outer layer by preventing ice from adhering to the outer layer;
a backer film attached to an underside of the icephobic outer layer; and
an adhesive attached to the backer film on an opposite side of the backer film relative to the icephobic outer layer.

2. The device of claim 1, wherein the icephobic outer layer includes an elastomeric reservoir at least partially saturated with an icephobic and/or hydrophobic lubricant.

3. The device of claim 2, wherein the backer film is chemically bonded to the elastomeric reservoir.

4. The device of claim 3, wherein the backer film and the icephobic outer layer are covalently bonded together.

5. The device of claim 3, wherein the backer film is made of PET or urethane.

6. The device of claim 3, wherein the adhesive is made of a material that chemically bonds with the backer film.

7. The device of claim 6, wherein the adhesive is a pressure sensitive adhesive (PSA).

8. The device of claim 6, wherein the adhesive is configured to bond to at least one of aluminum, fiberglass, or composite material.

9. The device of claim 3, wherein the backer film is silanized to bond to the elastomeric reservoir.

10. The device of claim 3, wherein the elastomeric reservoir is made of silicone.

11. An aircraft anti-icing and/or deicing system, comprising:
an aircraft structure having a surface; and
an icephobic outer layer bonded to the surface of the aircraft structure and configured to prevent ice from forming and/or building up on the outer layer by preventing ice from adhering to the outer layer.

12. The system of claim 11, wherein the structure is a pneumatic deicing bladder.

13. The system of claim 11, wherein the structure is an electrically heated deicer.

14. The system of claim 11, wherein the icephobic outer layer includes an elastomeric reservoir at least partially saturated with an icephobic and/or hydrophobic lubricant.

15. The system of claim 14, wherein the elastomeric reservoir is chemically bonded directly to the surface of the structure.

16. The system of claim 15, wherein the surface of the structure is silanized to bond to the elastomeric reservoir.

17. The system of claim 11, wherein the structure is an aircraft wing.

18. The system of claim 17, wherein the icephobic outer layer is disposed on a majority of an upper surface of the wing.

19. The system of claim 17, wherein the structure is disposed downstream of a pneumatic or electrically heated deicer.

20. A method, comprising:
chemically bonding a backer film to an elastomeric reservoir that is saturated with an icephobic and/or hydrophobic lubricant; and
chemically bonding an adhesive to an opposite side of the backer film.
